(19) United States
(12) Patent Application Publication
(10) Pub. No.: US 2026/0214562 A1
(43) Pub. Date: Jul. 23, 2026

(54) SIGNALING ASSOCIATED WITH NETWORK SLICING

(71) Applicant: QUALCOMM Incorporated, San Diego, CA (US)

(72) Inventors: Shankar KRISHNAN, Poway, CA (US); Stefano FACCIN, San Ysidro, CA (US); Prasad Reddy KADIRI, San Diego, CA (US); Geetha Priya RAJENDRAN, Bangalore (IN)

(21) Appl. No.: 19/137,875

(22) PCT Filed: Feb. 14, 2024
(86) PCT No.: PCT/US2024/015777

§ 371 Date: Jun. 11, 2025

(30) Foreign Application Priority Data
Feb. 16, 2023 (IN) 202321010361

(51) Int. Cl. H04W 48/18; H04W 76/19; H04W 76/30

(52) U.S. Cl. CPC H04W 48/18; H04W 76/19; H04W 76/30

(57) ABSTRACT

Various aspects of the present disclosure generally relate to wireless communication. In some aspects, an access and mobility management function (AMF) may communicate signaling associated with supporting one or more of: a network slice service continuity, a network slice service area, a temporary network slice, a partially allowed single-network slice selection assistance information (S-NSSAI), or a partially rejected S-NSSAI. The AMF may communicate a response based at least in part on the signaling. Numerous other aspects are described.

### CROSS-REFERENCE TO RELATED APPLICATION

This Patent Application claims priority to India Provisional Patent Application No. 202321010361, filed on Feb. 16, 2023, entitled “SIGNALING ASSOCIATED WITH NETWORK SLICING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for signaling associated with network slicing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at an access and mobility management function (AMF) includes a memory and one or more processors, coupled to the memory, configured to: communicate signaling associated with supporting one or more of: a network slice service continuity, a network slice service area, a temporary network slice, a partially allowed single-network slice selection assistance information (S-NSSAI), or a partially rejected S-NSSAI; and communicate a response based at least in part on the signaling.

In some implementations, an apparatus for wireless communication at a network node includes a memory and one or more processors, coupled to the memory, configured to: communicate signaling associated with supporting one or more of: a network slice service continuity, a network slice service area, a temporary network slice, a partially allowed S-NSSAI, or a partially rejected S-NSSAI; and communicate a response based at least in part on the signaling.

In some implementations, a method of wireless communication performed by an AMF includes communicating signaling associated with supporting one or more of: a network slice service continuity, a network slice service area, a temporary network slice, a partially allowed S-NSSAI, or a partially rejected S-NSSAI; and communicating a response based at least in part on the signaling.

In some implementations, a method of wireless communication performed by a network node includes communicating signaling associated with supporting one or more of: a network slice service continuity, a network slice service area, a temporary network slice, a partially allowed S-NSSAI, or a partially rejected S-NSSAI; and communicating a response based at least in part on the signaling.

In some implementations, a non-transitory computer-readable medium storing a set of instructions for wireless communication includes one or more instructions that, when executed by one or more processors of an AMF, cause the AMF to: communicate signaling associated with supporting one or more of: a network slice service continuity, a network slice service area, a temporary network slice, a partially allowed S-NSSAI, or a partially rejected S-NSSAI; and communicate a response based at least in part on the signaling.

In some implementations, a non-transitory computer-readable medium storing a set of instructions for wireless communication includes one or more instructions that, when executed by one or more processors of a network node, cause the network node to: communicate signaling associated with supporting one or more of: a network slice service continuity, a network slice service area, a temporary network slice, a partially allowed S-NSSAI, or a partially rejected S-NSSAI; and communicate a response based at least in part on the signaling.

In some implementations, an apparatus for wireless communication includes means for communicating signaling associated with supporting one or more of: a network slice service continuity, a network slice service area, a temporary network slice, a partially allowed S-NSSAI, or a partially rejected S-NSSAI; and means for communicating a response based at least in part on the signaling.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples associated with signaling associated with network slicing, in accordance with the present disclosure.

FIGS. 6-7 are diagrams illustrating example processes associated with signaling associated with network slicing, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

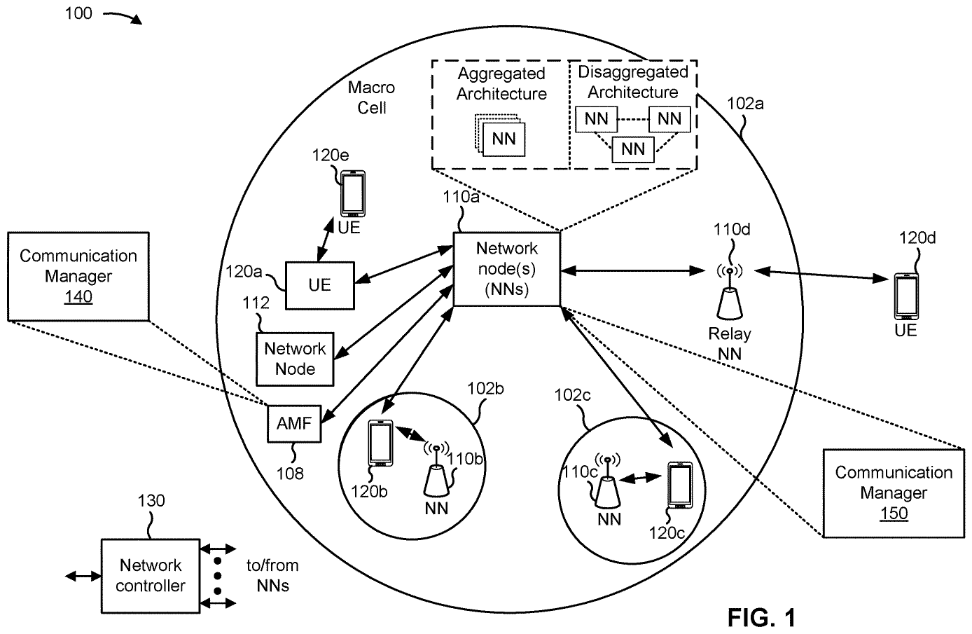

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an access and mobility management function (AMF) (e.g., AMF 108) may include a communication manager 140. As described in more detail elsewhere herein, the communication manager 140 may communicate signaling associated with supporting one or more of: a network slice service continuity, a network slice service area, a temporary network slice, a partially allowed single-network slice selection assistance information (S-NSSAI), or a partially rejected S-NSSAI; and communicate a response based at least in part on the signaling. Additionally, or alternatively, the communication manager 140 may perform one or more other operations described herein.

In some aspects, a network node (e.g., network node 110) may include a communication manager 150. As described in more detail elsewhere herein, the communication manager 150 may communicate signaling associated with supporting one or more of: a network slice service continuity, a network slice service area, a temporary network slice, a partially allowed S-NSSAI, or a partially rejected S-NSSAI; and communicate a response based at least in part on the signaling. Additionally, or alternatively, the communication manager 150 may perform one or more other operations described herein.

As indicated above, FIG. 1 is provided as an example. Other examples may differ from what is described with regard to FIG. 1.

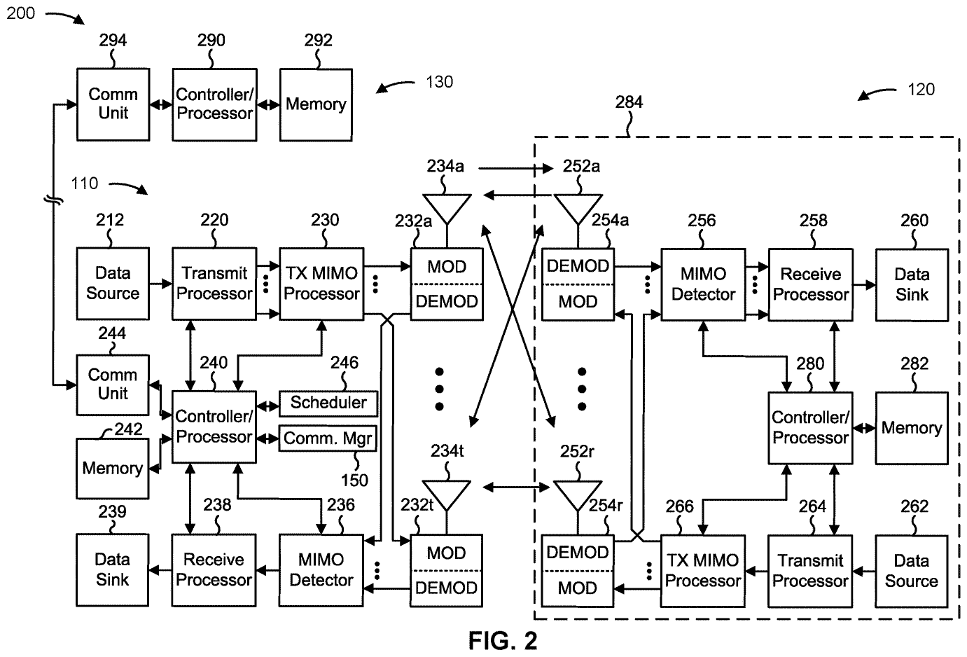

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

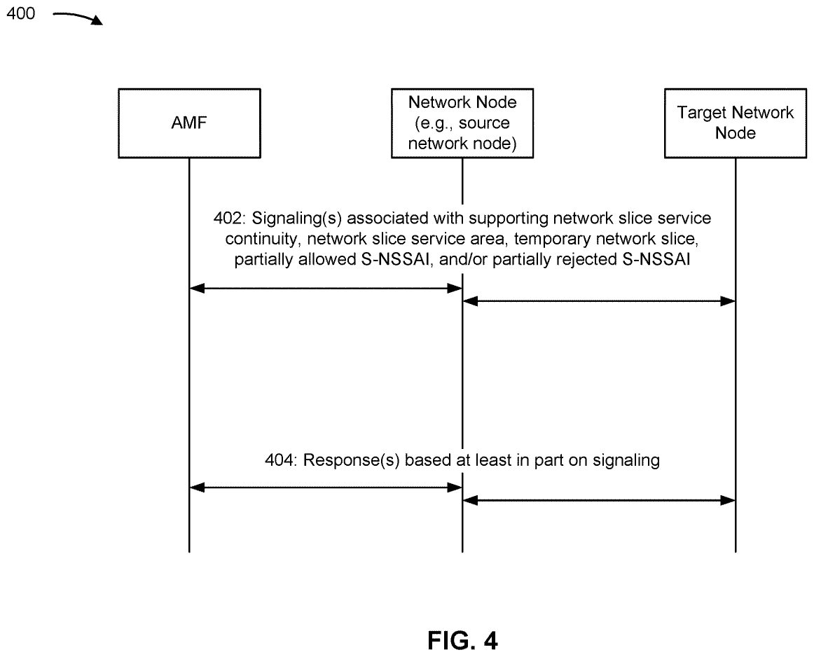

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

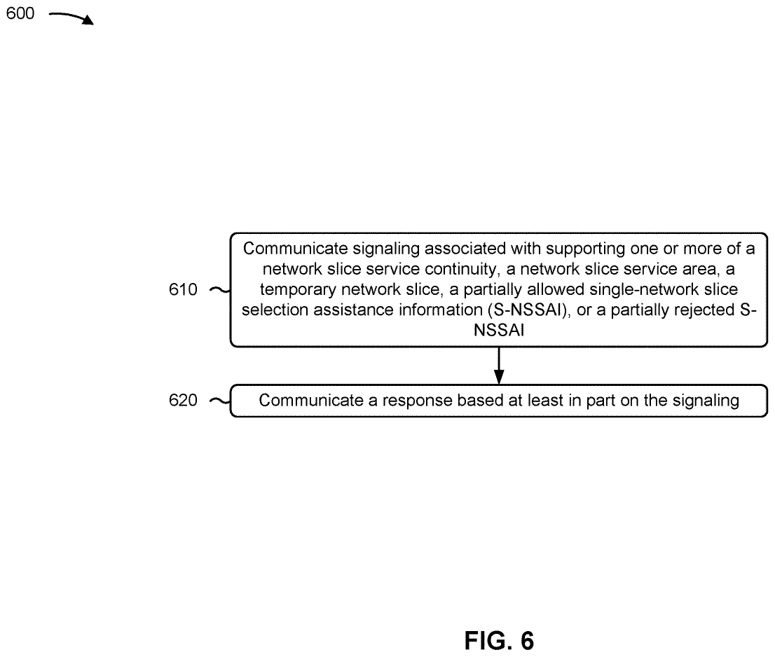

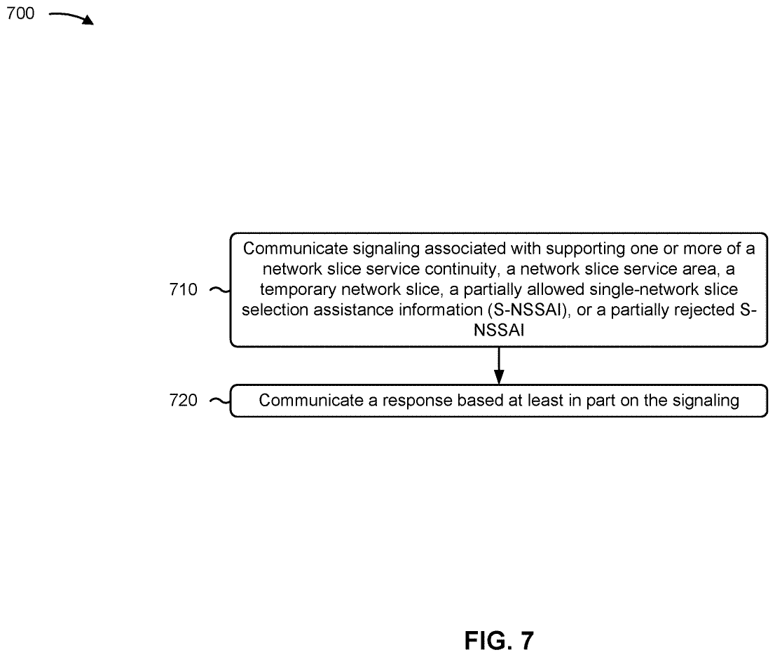

The controller/processor 240 of the network node 110, the controller/processor 280 of the UE 120, and/or any other component(s) of FIG. 2 may perform one or more techniques associated with signaling associated with network slicing, as described in more detail elsewhere herein. In some aspects, the AMF described herein includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, an AMF (e.g., AMF 108) includes means for communicating signaling associated with supporting one or more of: a network slice service continuity, a network slice service area, a temporary network slice, a partially allowed S-NSSAI, or a partially rejected S-NSSAI; and/or means for communicating a response based at least in part on the signaling. In some aspects, the means for the AMF to perform operations described herein may include, for example, one or more of communication manager 140, transmit processor 220, TX MIMO processor 230, modem 232, antenna 234, MIMO detector 236, receive processor 238, controller/processor 240, memory 242, or scheduler 246.

In some aspects, a network node (e.g., network node 110) includes means for communicating signaling associated with supporting one or more of: a network slice service continuity, a network slice service area, a temporary network slice, a partially allowed S-NSSAI, or a partially rejected S-NSSAI; and/or means for communicating a response based at least in part on the signaling. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

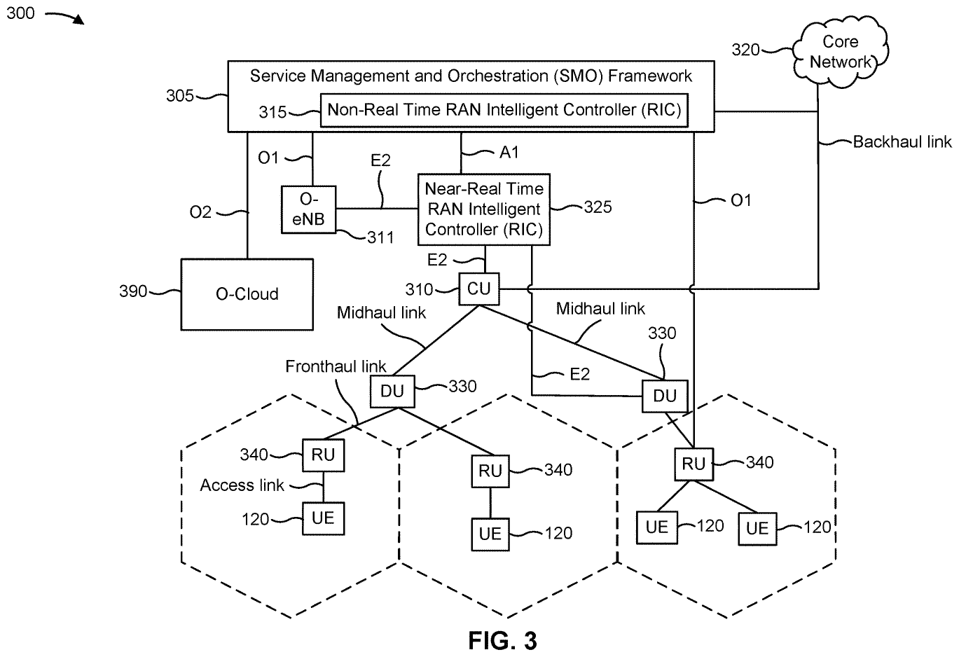

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

Network slicing, such as a 5G network slicing, is a network architecture that allows for the multiplexing of virtualized and independent logical networks on the same physical network infrastructure. A network slice may be an isolated end-to-end network, which may be tailored to fulfill diverse requirements requested by a particular application. The network slice, which may be a portion of the network, may be allocated based at least in part on the specific needs of the application, use case, and/or customer. The network slice may be associated with its own logical topology, security rules, and/or characteristics. 5G service types that may use network slicing for differential handling of traffic may include enhanced mobile broadband (eMBB), massive machine-type communications (mMTC), and/or ultra-reliable low-latency communications (URLLC). An eMBB service may provide mobile data access to UEs that are densely collected in a single area, UEs that are relatively mobile, and/or UEs that are spread over relatively wide areas. An mMTC service may provide data access to a relatively large number of devices in a small area with the expectation that the devices generate relatively little data and may be able to tolerate a relatively high latency. A URLLC service may deliver secure communications with relatively low latency and with relatively high reliability.

A legacy network slicing design does not address various scenarios. For example, the legacy network slicing design does not specify solutions to support a network slice service continuity, which may be needed when a network slide is overloaded, the network slide is not or available, or the network slice no longer satisfies a service level agreement (SLA). The legacy network slicing design does not specify solutions to support a network slice area of service for services not mapping to existing tracking area boundaries, as well as a temporary network slice. Further, the legacy network slicing design does not specify solutions describing registration areas, which may include tracking areas, supporting partially allowed S-NSSAIs and partially rejected S-NSSAIs. By not addressing such scenarios, a network performance associated with a network slicing may be degraded.

In various aspects of techniques and apparatuses described herein, an AMF may communicate signaling associated with supporting a network slice service continuity, a network slice service area, a temporary network slice, a partially allowed S-NSSAI, and/or a partially rejected S-NSSAI. The AMF may transmit the signaling to a network node, and/or the AMF may receive the signaling from the network node. The AMF may communicate a response based at least in part on the signaling. The AMF may transmit the response to a network node, and/or the AMF may receive the response from the network node.

In some aspects, a first objective may specify solutions to support the network slice service continuity. A second objective may specify solutions to support the network slice service area, which may not map to existing tracking area boundaries, as well as the temporary network slice. A third objective may specify solutions that enable registration areas, which may include tracking areas, to support partially allowed S-NSSAIs and partially rejected S-NSSAIs. The signaling communicated by the AMF may satisfy the first objective, the second objective, and the third objective, thereby improving a network performance associated with a network slicing (e.g., better data rates with a lower likelihood of stoppages in service).

FIG. 4 is a diagram illustrating an example 400 associated with signaling associated with network slicing, in accordance with the present disclosure. As shown in FIG. 4, example 400 includes communication between an AMF (e.g., AMF 108), a network node (e.g., network node 110, which in some cases, may be a source network node), and a target network node (e.g., network node 112). In some aspects, the AMF, the network node, and the target network node may be included in a wireless network, such as wireless network 100.

As shown by reference number 402, the AMF may communicate signaling associated with supporting a network slice service continuity, a network slice service area, a temporary network slice, a partially allowed S-NSSAI, and/or a partially rejected S-NSSAI. For example, when communicating the signaling, the AMF may receive, from the network node, signaling associated with supporting the network slice service continuity, the network slice service area, the temporary network slice, the partially allowed S-NSSAI, and/or the partially rejected S-NSSAI. As another example, when communicating the signaling, the AMF may transmit, to the network node, signaling associated with supporting the network slice service continuity, the network slice service area, the temporary network slice, the partially allowed S-NSSAI, and/or the partially rejected S-NSSAI.

In some aspects, additionally, or alternatively, the network node may communicate signaling associated with supporting the network slice service continuity, the network slice service area, the temporary network slice, the partially allowed S-NSSAI, and/or the partially rejected S-NSSAI. For example, when communicating the signaling, the network node may receive, from the AMF and/or the target network node (e.g., when the network node is a source network node), signaling associated with supporting the network slice service continuity, the network slice service area, the temporary network slice, the partially allowed S-NSSAI, and/or the partially rejected S-NSSAI. As another example, when communicating the signaling, the network node may transmit, to the AMF and/or the target network node, signaling associated with supporting the network slice service continuity, the network slice service area, the temporary network slice, the partially allowed S-NSSAI, and/or the partially rejected S-NSSAI.

As shown by reference number 404, the AMF may communicate a response based at least in part on the signaling. For example, when communicating the response, the AMF may receive the response from the network node. As another example, when communicating the response, the AMF may transmit the response to the network node. In some aspects, additionally, or alternatively, the network node may communicate the response based at least in part on the signaling. For example, when communicating the response, the network node may receive, from the AMF and/or the target network node (e.g., when the network node is a source network node), the response. As another example, when communicating the response, the network node may transmit, to the AMF and/or the target network node, the response.

In some aspects, a first objective may be associated with the network slice service continuity (e.g., which may occur when a network slice is overloaded, not available, or no longer satisfies an SLA). The AMF may determine an alternative S-NSSAI, and the AMF may trigger an S-NSSAI replacement based at least in part on signaling with an operations, administration and maintenance (OAM) function, an access and mobility management (AM) policy charging function (PCF), and/or a network slice selection function (NSSF). The S-NSSAI replacement may involve replacing an existing S-NSSAI with the alternative S-NSSAI. The AMF may determine the alternative S-NSSAI (e.g., a network slice instance (NSI) reselection) when a UE establishes a new protocol data unit (PDU) session. The UE may receive an indication of the alternative S-NSSAI via a registration procedure or via a UE configuration update procedure.

In some aspects, the S-NSSAI replacement may be supported for the new PDU session, which may be based at least in part on a session management function (SMF) providing an indication of the alternative S-NSSAI to the UE after receiving the indication of the alternative S-NSSAI from the AMF. In some aspects, the S-NSSAI replacement may be supported for an existing PDU session without a PDU session reestablishment, which may be based at least in part on the SMF providing an indication of the alternative S-NSSAI to the UE, a radio access network (RAN), and/or a user plane function (UPF) after receiving the indication of the alternative S-NSSAI from the AMF. In some aspects, the S-NSSAI replacement may be supported for an existing PDU session using a PDU session reestablishment, which may be based at least in part on the SMF providing an indication of the alternative S-NSSAI to the UE after receiving the indication of the alternative S-NSSAI from the AMF.

In some aspects, the network slice service continuity may be needed in various scenarios. In a first scenario, a network slice may be overloaded in a Next Generation radio access network (NG-RAN). In a second scenario, a network slice in the target network node (e.g., a target NG-RAN node) may be overloaded. In a third scenario, the network slice or a network slice instance may be overloaded, or may be undergoing a planned maintenance in a core network (e.g., a network slice termination). In a fourth scenario, a network performance of the network slice may be unable to meet an SLA. In a fifth scenario, the network slice may not be supported in the target network node. For example, the source network node (e.g., a source NG-RAN node) may be associated with a first registration area. The source network node may support a first network slice. The target network node may be associated with a second registration area. The target network node may not support the first network slice, but rather may only support a second network slice. In a sixth scenario, the network slice may not be supported in a target core network. In a seventh scenario, the network slice or the network slice instance may be overloaded in a target core network. In such scenarios, an alternative S-NSSAI may act as a backup to provide the network slice service continuity without a PDU session reestablishment.

In some aspects, the AMF, when communicating the signaling, may transmit, to the network node and based at least in part on supporting the network slice service continuity, an indication of an alternative S-NSSAI during a PDU session or modification. The alternative S-NSSAI may be associated with the S-NSSAI replacement for the existing PDU session without the PDU session reestablishment. In some aspects, the network node may be the source network node, and the source network node, when communicating the signaling, may transmit to the target network node and based at least in part on supporting the network slice service continuity, an indication of the alternative S-NSSAI during a handover or during a retrieval of UE context information. The alternative S-NSSAI may be associated with the S-NSSAI replacement for the existing PDU session without the PDU session reestablishment.

In some aspects, in order to support the S-NSSAI replacement for the existing PDU session without the PDU session reestablishment, the AMF may indicate the alternative S-NSSAI to the network node (e.g., an NG-RAN node) during a PDU session setup/modification and initial context setup. The AMF may indicate the alternative S-NSSAI using a newly defined “Alternative S-NSSAI” information element (IE), which may be indicated in a PDU session resource setup/modify request and/or in an initial context setup request. For example, the PDU session resource setup/modify request may be a message transmitted by the AMF to the network node, where the message may be used to request the network node to enable modifications of already established PDU session resources for the UE. The PDU session resource setup/modify request may include the “Alternative S-NSSAI” IE.

In some aspects, during a handover or during a retrieval of UE context information, the source network node may indicate the alternative S-NSSAI to the target network. The source network node may exchange the alternative S-NSSAI with the target network node. For example, the source network node may transmit, to the target network node, a handover request or a secondary node additional request. The handover request or the secondary node additional request may include a “PDU session resources to be setup/added” IE, which may indicate the alternative S-NSSAI.

In some aspects, a second objective may be associated with a network slice validity and temporary network slices. Some network slices may have areas of service that do not match with existing tracking areas, where a tracking area may be a group of cells. To support the network slices having the areas of service not matching the existing tracking areas, a network slice validity policy may be provided to the UE. The network slice validity policy may indicate location information. The network slice validity policy may be provided to the UE via a registration procedure or via a UE configuration update procedure. Further, radio resource management (RRM) policies for S-NSSAIs may be configured on a per-cell basis, while a core network may support a network-slice-per-tracking-area level. To support the temporary network slices, which may be network slices having a limited lifetime, the network slice validity policy provided to the UE via the registration procedure or the UE configuration update procedure may include timing information. The AMF may enforce S-NSSAI availability policies, which may occur when the UE does not support the S-NSSAI availability policies based at least in part on the AMF subscribing to an area of interest. Further, a graceful or gradual termination of PDU sessions may be supported during a network slice decommissioning for UEs supporting the timing information and for UEs not supporting the timing information.

In some aspects, the area of service associated with the network slice may not match with tracking area boundaries. Network slices may be deployed for services over an area of service, which may match with existing tracking areas or for which the area of service may be different. In the past, a network slice availability, which may define areas in which network slices are to be supported, may be designed to match deployed tracking area boundaries, but in some cases, services over network slices may need to be supported when the services have the area service which does not match with the existing deployed tracking area boundaries.

In some aspects, the network node may be the source network node, and the source network node, when communicating the signaling, may transmit, to the target network node based at least in part on supporting the network slice service area, which may not match the existing tracking area, signaling associated with an initiation of a handover. The handover may be to the target network node, which may be within the network slice service area. In some aspects, the target network node, when communicating signaling, may receive, from the source network node and based at least in part on supporting the network slice service area, which may not match the existing tracking area, signaling associated with an initiation of a handover. The signaling may not consider the network slice service area. The target network node may perform an admission control based at least in part on the network slice service area. The admission control may be for a cell that is within the network slice service area. In some aspects, multiple cells may satisfy a conditional handover execution threshold during a conditional handover. A cell of the multiple cells that is within the network slice service area may be prioritized over a cell of the multiple cells that is outside of the network slice service area

In some aspects, when network slices have areas of service not matching with deployed tracking areas, the handover may be optimized to prevent the UE from leaving the network slice service area, or steer the UE such that the UE enters into the network slice service area. In a first option, the source network node may initiate a handover preparation only towards target network nodes that are within the network slice service area. In a second option, the source network node may initiate a handover preparation without considering the network slice service area. Rather, the target network node (e.g., a target gNB) may perform the admission control while taking the network slice service area into account. The target network node may allow admission control to only those cells that are within the network slice service area. In a third option, in the case of the conditional handover, when multiple cells satisfy the conditional handover execution threshold, the UE may prioritize handing over to cells that are within the network slice service area. As a result, the UE may be prevented from leaving the network slice service area, or may be steered to enter the network slice service area.

In some aspects, a PDU session may be handed over to a cell, even when a network slice associated with the PDU session has zero configured resources. The network slice may not have any resources (e.g., zero resources) configured for the network slice, in which case no data transmission may occur for the PDU session of the network slice. The PDU session may be retained after a connected mode mobility of the UE. The PDU session may be maintained after a successful handover of the UE (e.g., a PDU session release may not be triggered), even when no resources are configured for the network slice, such that the PDU session does not need to be reestablished in case the UE shortly moves into an area with resources configured for that network slice. In other words, retaining the PDU session may avoid the PDU session reestablishment at a later point in time.

In some aspects, the AMF, when communicating the signaling, may transmit, to the network node and based at least in part on supporting the network slice service area, a location reporting control information that indicates an event type and an area of interest. The event type may be associated with a UE presence in the area of interest.

The area of interest may be associated with an S-NSSAI, an indication that no user plane resources are configured for the S-NSSAI, and a PDU session identifier that is not associated with user plane resources. The AMF, when communicating the response, may receive, from the network node and based at least in part on supporting the network slice service area, a location report that indicates the UE presence in the area of interest. The location report may be based at least in part on the UE moving outside of the network slice service area, which may be associated with the S-NSSAI, or based at least in part on the UE moving to a cell in which no user plane resources are allocated for the S-NSSAI. In some aspects, the network node, when communicating the signaling, may transmit, to the UE and based at least in part on supporting the network slice service area, an indication of the network slice service area via dedicated signaling. A network-slice-specific cell reselection may be based at least in part on the network slice service area.

In some aspects, an area of interest reporting may be configured to notify a core network when the UE is outside of the area of interest. When the area of interest is associated with an area of service (e.g., the network slice service area) of the S-NSSAI, the area of interest may be identified using the S-NSSAI. The S-NSSAI may be used as an area of interest identifier to indicate resource that are allocated for the S-NSSAI.

In some aspects, the AMF may configure the network node to report the UE's presence in the area of interest when the UE moves outside of the area of service, which may be based at least in part on a configured list of one or more S-NSSAIs), or only when the UE moves to a location in which no user plane resources are allocated for the one or more configured S-NSSAIs. The report indicating the UE's presence in the area of interest may indicate whether the UE is inside the area of interest, whether the UE is outside of the area of interest, or whether the UE is inside or outside of the area of interest is unknown. The AMF may indicate, to the network node, an area of interest IE, which may be an IE that indicates the area of interest. The area of interest IE may indicate an S-NSSAI along with an indication of no user plane resources and a PDU session identifier, which may be associated with no user plane resources. In other words, the area of interest IE may indicate an area of interest slice list, which may include an indication of the S-NSSAI, the indication of the no user plane resources, and the PDU session identifier.

In some aspects, the network node may notify the AMF when the UE moves outside of the area of service of the S-NSSAI, or when the UE moves to a cell in which no user plane resources are allocated for the one or more configured S-NSSAIs. The network node may notify the AMF via the location report, which may be transmitted by the network node to the AMF. In some aspects, the network node may signal an indication of an area of service of a network slice to the UE via dedicated signaling, which may assist the UE to perform a network-slice-specific cell reselection. The dedicated signaling may be associated with an RRC release message or an RRC reconfiguration message.

In some aspects, the AMF may transmit, to the network node, a location reporting control message (e.g., the location reporting control information). The location reporting control message may indicate an event type. The event type may be associated with a change of serving cell, or a UE presence in the area of interest. The location reporting control message may indicate the area of interest (e.g., the area of interest IE). The area of interest may be associated with tracking area identities (TAIs), cells, RAN nodes, S-NSSAIs, an indication of no user plane resources being configured, and/or a PDU session identifier. The network node may transmit, to the AMF and based at least in part on an event being met, the location report. The location report may indicate a location reporting reference identifier. The location report may indicate the UE presence in the area of interest (e.g., in the area of interest, outside of the area of interest, or unknown).

In some aspects, the AMF, when communicating the signaling, may receive, from the network node and based at least in part on supporting the network slice service area, an indication that the UE has moved to an area that is outside of the network slice service area. The area may be associated with no user plane resources. The PDU session may be released based at least in part on the indication, or a user plane connection for the PDU session may be deactivated while maintaining the PDU session. In some aspects, the network node, when communicating the signaling, may receive, from the AMF and based at least in part on supporting the network slice service area, a configuration to deactivate user plane resources of the PDU session of the UE after the UE moves to the area that is outside of the network slice service area and the area is associated with no user plane resources. The network node may detect that the UE has moved to the area that is outside of the network slice service area and associated with no user plane resources. The network node may initiate a deactivation of the user plane resources. The network node, when communicating the response, may transmit, to the AMF, an indication of the deactivation of the user plane resources. Additionally, or alternatively, the network node, when communicating the response, may transmit, to the UE and via dedicated signaling, the indication of the deactivation of the user plane resources.

In some aspects, the network node may be configured to trigger the release of PDU sessions, or the deactivation of user plane resources of PDU sessions according to a policy, as the UE is moving to an area in which zero resources are allocated to a corresponding network slice. When the UE is moving to the area in which zero resources are allocated to the corresponding network slice, one of two options may be employed. In a first option, a local area data network (LADN)-like solution, which may be SMF controlled, may be employed. The network node may report, to the AMF (which may report to the SMF), that the UE has moved to the area in which no resources are allocated to the corresponding network slice. When the SMF is notified that the UE is outside of the network slice service area, the SMF may release the PDU session, or the SMF may deactivate a user plane connection for the PDU session while maintaining the PDU session. In a second option, a network-node-initiated user plane resource deactivation may be employed. The AMF may configure the network node to deactivate the user plane resources of the PDU sessions after the UE moves to the area in which zero resources are allocated to the corresponding network slice. For example, the AMF may configure the network node to deactivate the user plane resources of the PDU sessions using a one-bit flag, or a one-bit flag per PDU session. The network node may detect that the UE has moved into the area, and the network node may initiate the deactivation of the user plane resources (e.g., using a data radio bearer (DRB) release). The network node may notify the AMF regarding the deactivation of the user plane resources, and the AMF may notify the SMF and/or the UPF of the deactivation of the user plane resources. Alternatively, the network node may also indicate to the UE, via dedicated signaling (e.g., an RRC reconfiguration message), that the network node is not allocating user plane resources for downlink data for a next time duration, such that the UE may not monitor downlink resources.

In some aspects, the AMF, when communicating the signaling, may transmit, to the network node and based at least in part on supporting the temporary network slice, network slice validity information that indicates time validity information and location restrictions for network slices. The network slice validity information may be associated with avoiding triggering a Next Generation (NG) interface release due to user inactivity.

In some aspects, the network node may request the AMF to release the NG interface due to user inactivity. The network node may request the AMF to release the NG interface due to user inactivity on a plurality of PDU sessions (e.g., all PDU sessions). The NG interface may be requested to be released in order to conserve radio resources. When a temporal validity of an S-NSSAI (e.g., 30 minutes) is greater than an inactivity timer for releasing the NG interface (e.g., 15 minutes), the AMF may notify the network node of the temporal validity of the S-NSSAI, such that the network node does not trigger the NG interface release due to user inactivity. The AMF may transmit, to the network node, the network slice validity information, which may indicate the validity information and/or the location restrictions for the network slices. The AMF may indicate the network slice validity information during an initial UE context setup, a PDU session setup/modification, or an NG-based handover.

In some aspects, a third objective may be associated with partially allowed S-NSSAIs and partially rejected S-NSSAIs. The UE may be provided with information related to supported or not supported tracking areas, which may be associated with some S-NSSAIs what are partially allowed in a registration area. The UE may be provided with information related to supported or not supported tracking areas, which may be associated with some S-NSSAIs what are partially rejected in the registration area. In both cases, the UE may be provided with the information via the registration procedure or via the configuration update procedure. Further, an indication of a partially or conditionally allowed S-NSSAI may be provided to the network node.

In some aspects, the partially allowed S-NSSAI may be based at least in part on an allowed S-NSSAI that is indicated to be supported not fully within the registration area. The AMF may provide, to the UE and for the S-NSSAI, a list of TAIs in which the S-NSSAI is partially allowed. A partially rejected S-NSSAI may be based at least in part on a rejected S-NSSAI that is supported in some TAIs of the registration area (and thus, is partially rejected). The AMF may provide, to the UE, an indication of the partially rejected S-NSSAI with a list of tracking areas. The UE may provide, to the UE, a new cause that indicates tracking areas in which the S-NSSAI is supported (or not supported) in the registration area.

In some aspects, the AMF, when communicating the signaling, may transmit, to the network node and based at least in part on supporting the partially allowed S-NSSAI, a message that includes an indication of the partially allowed S-NSSAI and an indication of an allowed S-NSSAI. In some aspects, the AMF, when communicating the signaling, may transmit, to the network node and based at least in part on supporting the partially rejected S-NSSAI, a message that includes an indication of the partially rejected S-NSSAI and an indication of an allowed S-NSSAI.

In some aspects, the AMF may transmit, to the network node, an indication of the partially allowed S-NSSAI. The AMF may transmit the indication of the partially allowed S-NSSAI, along with an indication of allowed S-NSSAIs, in the same message. The AMF may transmit the indication of the partially allowed S-NSSAI in an initial context setup request. The AMF may transmit the indication of the partially allowed S-NSSAI in a connection establishment indication. The AMF may transmit the indication of the partially allowed S-NSSAI in an AMF control plane relocation indication. The AMF may transmit the indication of the partially allowed S-NSSAI in a UE information transfer message. The AMF may transmit the indication of the partially allowed S-NSSAI in a handover request. The AMF may transmit the indication of the partially allowed S-NSSAI in a path switch acknowledge message. The AMF may transmit the indication of the partially allowed S-NSSAI in an initial UE message. The AMF may transmit the indication of the partially allowed S-NSSAI in a downlink non-access stratum (NAS) transport message. The AMF may transmit the indication of the partially allowed S-NSSAI in a reroute NAS request. In some aspects, the AMF may transmit, to the network node, an indication of the partially rejected S-NSSAI. The AMF may transmit the indication of the partially rejected S-NSSAI, along with the indication of allowed S-NSSAIs, in the same message.

As indicated above, FIG. 4 is provided as an example. Other examples may differ from what is described with regard to FIG. 4.

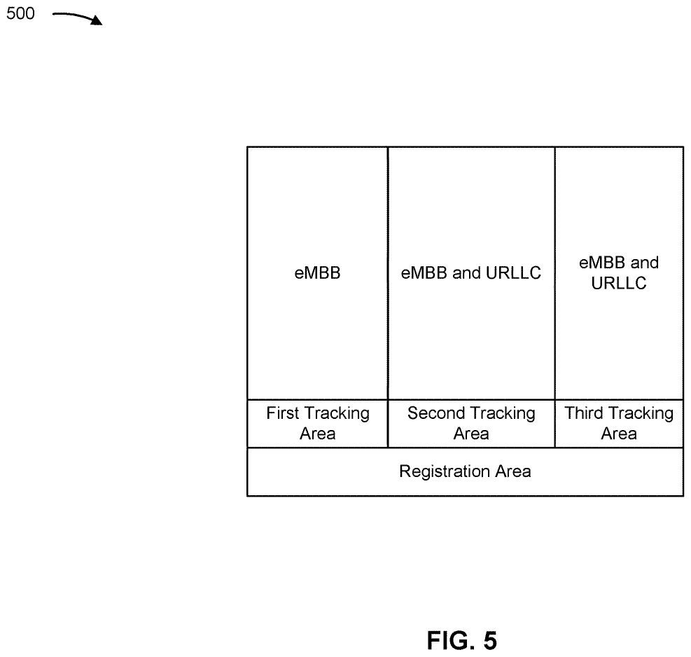

FIG. 5 is a diagram illustrating an example 500 associated with signaling associated with network slicing, in accordance with the present disclosure.

As shown in FIG. 5, a registration area may be associated with a first tracking area, a second tracking area, and a third tracking area. The first tracking area may be associated with eMBB (or an eMBB network slice). The second tracking area may be associated with eMBB and URLLC (or an URLLC network slice). The third tracking area may be associated with eMBB and URLLC. A UE may attempt to perform an initial access in the first tracking area. During the initial access, a requested S-NSSAI may indicate eMBB and URLLC, but an allowed S-NSSAI may be only eMBB. In a first option, a partially allowed S-NSSAI may indicate URLLC and a partial registration area of the second tracking area and the third tracking area. In other words, URLLC may be only supported for a list of TAIs containing the second tracking area and the third tracking area. In a second option, a partially rejected S-NSSAI may indicate URLLC is rejected in the first tracking area (with a cause of partly rejected in the registration area), but that URLLC is supported in the second tracking area and the third tracking area.

As indicated above, FIG. 5 is provided as an example. Other examples may differ from what is described with regard to FIG. 5.

FIG. 6 is a diagram illustrating an example process 600 performed, for example, by an AMF, in accordance with the present disclosure. Example process 600 is an example where the AMF (e.g., AMF 108) performs operations associated with signaling associated with network slicing.

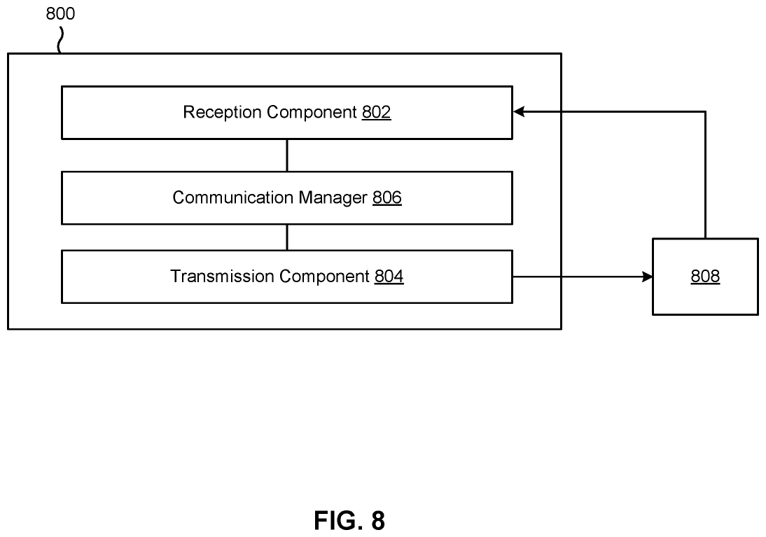

As shown in FIG. 6, in some aspects, process 600 may include communicating signaling associated with supporting one or more of: a network slice service continuity, a network slice service area, a temporary network slice, a partially allowed S-NSSAI, or a partially rejected S-NSSAI (block 610). For example, the AMF (e.g., using reception component 802, transmission component 804, and/or communication manager 806, depicted in FIG. 8) may communicate signaling associated with supporting one or more of: a network slice service continuity, a network slice service area, a temporary network slice, a partially allowed S-NSSAI, or a partially rejected S-NSSAI, as described above.

As further shown in FIG. 6, in some aspects, process 600 may include communicating a response based at least in part on the signaling (block 620). For example, the AMF (e.g., using reception component 802, transmission component 804, and/or communication manager 806, depicted in FIG. 8) may communicate a response based at least in part on the signaling, as described above.

Process 600 may include additional aspects, such as any single aspect or any combination of aspects described below and/or in connection with one or more other processes described elsewhere herein.

In a first aspect, process 600 includes transmitting, to a network node and based at least in part on supporting the network slice service continuity, an indication of an alternative S-NSSAI during a PDU session or modification, wherein the alternative S-NSSAI is associated with an S-NSSAI replacement for an existing PDU session without a PDU session reestablishment.

In a second aspect, alone or in combination with the first aspect, multiple cells satisfy a conditional handover execution threshold during a conditional handover, and a cell of the multiple cells that is within the network slice service area is prioritized over a cell of the multiple cells that is outside of the network slice service area.

In a third aspect, alone or in combination with one or more of the first and second aspects, process 600 includes transmitting, to a network node and based at least in part on supporting the network slice service area, a location reporting control information that indicates an event type and an area of interest, wherein the event type is associated with a UE presence in the area of interest, and the area of interest is associated with an S-NSSAI, an indication that no user plane resources are configured for the S-NSSAI, and a PDU session identifier that is not associated with user plane resources, and process 600 includes receiving, from the network node and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

In a fourth aspect, alone or in combination with one or more of the first through third aspects, process 600 includes receiving, from a network node and based at least in part on supporting the network slice service area, an indication that a UE has moved to an area that is outside of the network slice service area, wherein the area is associated with no user plane resources, and a PDU session is released based at least in part on the indication, or a user plane connection for the PDU session is deactivated while maintaining the PDU session.

In a fifth aspect, alone or in combination with one or more of the first through fourth aspects, process 600 includes transmitting, to a network node and based at least in part on supporting the network slice service area, a configuration to deactivate user plane resources of a PDU session of a UE after the UE moves to an area that is outside of the network slice service area and the area is associated with no user plane resources, and communicating the response comprises receiving, from the network node, an indication of a deactivation of the user plane resources.

In a sixth aspect, alone or in combination with one or more of the first through fifth aspects, process 600 includes transmitting, to a network node and based at least in part on supporting the temporary network slice, network slice validity information that indicates time validity information and location restrictions for network slices, wherein the network slice validity information is associated with avoiding triggering an NG interface release due to user inactivity.

In a seventh aspect, alone or in combination with one or more of the first through sixth aspects, process 600 includes transmitting, to a network node and based at least in part on supporting the partially allowed S-NSSAI, a message that includes an indication of the partially allowed S-NSSAI and an indication of an allowed S-NSSAI.

In an eighth aspect, alone or in combination with one or more of the first through seventh aspects, process 600 includes transmitting, to a network node and based at least in part on supporting the partially rejected S-NSSAI, a message that includes an indication of the partially rejected S-NSSAI and an indication of an allowed S-NSSAI.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with signaling associated with network slicing.

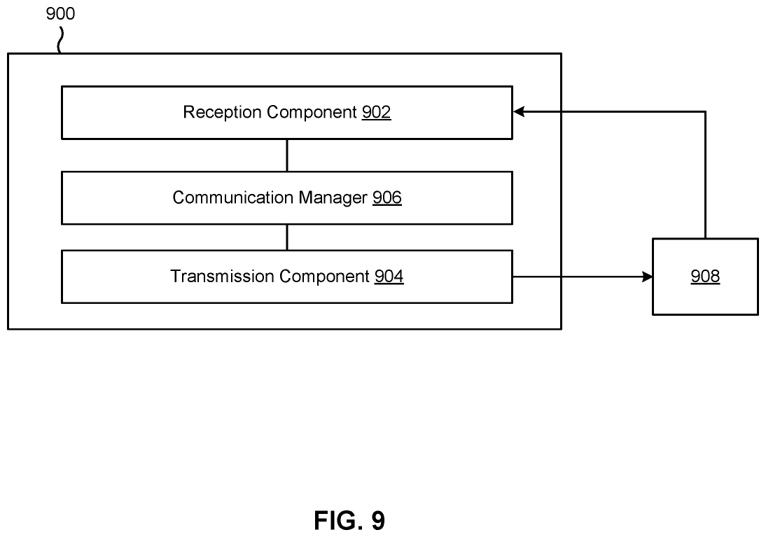

As shown in FIG. 7, in some aspects, process 700 may include communicating signaling associated with supporting one or more of: a network slice service continuity, a network slice service area, a temporary network slice, a partially allowed S-NSSAI, or a partially rejected S-NSSAI (block 710). For example, the network node (e.g., using reception component 902, transmission component 904, and/or communication manager 906, depicted in FIG. 9) may communicate signaling associated with supporting one or more of: a network slice service continuity, a network slice service area, a temporary network slice, a partially allowed S-NSSAI, or a partially rejected S-NSSAI, as described above.

As further shown in FIG. 7, in some aspects, process 700 may include communicating a response based at least in part on the signaling (block 720). For example, the network node (e.g., using reception component 902, transmission component 904, and/or communication manager 906, depicted in FIG. 9) may communicate a response based at least in part on the signaling, as described above.

Process 700 may include additional aspects, such as any single aspect or any combination of aspects described below and/or in connection with one or more other processes described elsewhere herein.

In a first aspect, process 700 includes receiving, from an AMF and based at least in part on supporting the network slice service continuity, an indication of an alternative S-NSSAI during a PDU session or modification, the alternative S-NSSAI is associated with an S-NSSAI replacement for an existing PDU session without a PDU session reestablishment.

In a second aspect, alone or in combination with the first aspect, the network node is a source network node, and process 700 includes transmitting, to a target network node and based at least in part on supporting the network slice service continuity, an indication of an alternative S-NSSAI during a handover or during a retrieval of UE context information, wherein the alternative S-NSSAI is associated with an S-NSSAI replacement for an existing PDU session without a PDU session reestablishment.

In a third aspect, alone or in combination with one or more of the first and second aspects, the network node is a source network node, and process 700 includes transmitting, to a target network node based at least in part on supporting the network slice service area, which does not correspond to an existing tracking area, signaling associated with an initiation of a handover, wherein the handover is to the target network node, which is within the network slice service area.

In a fourth aspect, alone or in combination with one or more of the first through third aspects, the network node is a target network node, and process 700 includes receiving, from a source network node and based at least in part on supporting the network slice service area, which does not correspond to an existing tracking area, signaling associated with an initiation of a handover, wherein the signaling is not based at least in part on the network slice service area, and process 700 includes performing an admission control based at least in part on the network slice service area, wherein the admission control is for a cell that is within the network slice service area.

In a fifth aspect, alone or in combination with one or more of the first through fourth aspects, multiple cells satisfy a conditional handover execution threshold during a conditional handover, and a cell of the multiple cells that is within the network slice service area is prioritized over a cell of the multiple cells that is outside of the network slice service area.

In a sixth aspect, alone or in combination with one or more of the first through fifth aspects, process 700 includes receiving, from an AMF and based at least in part on supporting the network slice service area, a location reporting control information that indicates an event type and an area of interest, wherein the event type is associated with a UE presence in the area of interest, and the area of interest is associated with an S-NSSAI, an indication that no user plane resources are configured for the S-NSSAI, and a PDU session identifier that is not associated with user plane resources, and process 700 includes transmitting, to the AMF and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

In a seventh aspect, alone or in combination with one or more of the first through sixth aspects, process 700 includes transmitting, to a UE and based at least in part on supporting the network slice service area, an indication of the network slice service area via dedicated signaling, wherein a network-slice-specific cell reselection is based at least in part on the network slice service area.

In an eighth aspect, alone or in combination with one or more of the first through seventh aspects, process 700 includes transmitting, to an AMF and based at least in part on supporting the network slice service area, an indication that a UE has moved to an area that is outside of the network slice service area, wherein the area is associated with no user plane resources, and a PDU session is released based at least in part on the indication, or a user plane connection for the PDU session is deactivated while maintaining the PDU session.

In a ninth aspect, alone or in combination with one or more of the first through eighth aspects, process 700 includes receiving, from an AMF and based at least in part on supporting the network slice service area, a configuration to deactivate user plane resources of a PDU session of a UE after the UE moves to an area that is outside of the network slice service area and the area is associated with no user plane resources; detecting that the UE has moved to the area that is outside of the network slice service area and associated with no user plane resources; and initiating a deactivation of the user plane resources; and process 700 includes one or more of transmitting, to the AMF, an indication of the deactivation of the user plane resources, or transmitting, to the UE and via dedicated signaling, the indication of the deactivation of the user plane resources.

In a tenth aspect, alone or in combination with one or more of the first through ninth aspects, process 700 includes receiving, from an AMF and based at least in part on supporting the temporary network slice, network slice validity information that indicates time validity information and location restrictions for network slices, wherein the network slice validity information is associated with avoiding triggering an NG interface release due to user inactivity.

In an eleventh aspect, alone or in combination with one or more of the first through tenth aspects, process 700 includes receiving, from an AMF and based at least in part on supporting the partially allowed S-NSSAI, a message that includes an indication of the partially allowed S-NSSAI and an indication of an allowed S-NSSAI.

In a twelfth aspect, alone or in combination with one or more of the first through eleventh aspects, process 700 includes receiving, from an AMF and based at least in part on supporting the partially rejected S-NSSAI, a message that includes an indication of the partially rejected S-NSSAI and an indication of an allowed S-NSSAI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a AMF, or a AMF may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the AMF described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the AMF described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the AMF described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 and/or the transmission component 804 may communicate signaling associated with supporting one or more of a network slice service continuity, a network slice service area, a temporary network slice, a partially allowed S-NSSAI, or a partially rejected S-NSSAI. The reception component 802 and/or the transmission component 804 may communicate a response based at least in part on the signaling.

The transmission component 804 may transmit, to a network node and based at least in part on supporting the network slice service continuity, an indication of an alternative S-NSSAI during a PDU session or modification, wherein the alternative S-NSSAI is associated with an S-NSSAI replacement for an existing PDU session without a PDU session reestablishment.

The transmission component 804 may transmit, to a network node and based at least in part on supporting the network slice service area, a location reporting control information that indicates an event type and an area of interest, wherein the event type is associated with a UE presence in the area of interest, and wherein the area of interest is associated with an S-NSSAI, an indication that no user plane resources are configured for the S-NSSAI, and a PDU session identifier that is not associated with user plane resources. The reception component 802 may receive, from the network node and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

The reception component 802 may receive, from a network node and based at least in part on supporting the network slice service area, an indication that a UE has moved to an area that is outside of the network slice service area, wherein the area is associated with no user plane resources, and a PDU session is released based at least in part on the indication, or a user plane connection for the PDU session is deactivated while maintaining the PDU session.

The transmission component 804 may transmit, to a network node and based at least in part on supporting the network slice service area, a configuration to deactivate user plane resources of a PDU session of a UE after the UE moves to an area that is outside of the network slice service area and the area is associated with no user plane resources. The reception component 802 may receive, from the network node, an indication of a deactivation of the user plane resources.

The transmission component 804 may transmit, to a network node and based at least in part on supporting the temporary network slice, network slice validity information that indicates time validity information and location restrictions for network slices, wherein the network slice validity information is associated with avoiding triggering an NG interface release due to user inactivity.

The transmission component 804 may transmit, to a network node and based at least in part on supporting the partially allowed S-NSSAI, a message that includes an indication of the partially allowed S-NSSAI and an indication of an allowed S-NSSAI. The transmission component 804 may transmit, to a network node and based at least in part on supporting the partially rejected S-NSSAI, a message that includes an indication of the partially rejected S-NSSAI and an indication of an allowed S-NSSAI.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 and/or the transmission component 904 may communicate signaling associated with supporting one or more of a network slice service continuity, a network slice service area, a temporary network slice, a partially allowed S-NSSAI, or a partially rejected S-NSSAI. The reception component 902 and/or the transmission component 904 may communicate a response based at least in part on the signaling.

The reception component 902 may receive, from an AMF and based at least in part on supporting the network slice service continuity, an indication of an alternative S-NSSAI during a PDU session or modification, wherein the alternative S-NSSAI is associated with an S-NSSAI replacement for an existing PDU session without a PDU session reestablishment.

The transmission component 904 may transmit, to a target network node and based at least in part on supporting the network slice service continuity, an indication of an alternative S-NSSAI during a handover or during a retrieval of UE context information, wherein the alternative S-NSSAI is associated with an S-NSSAI replacement for an existing PDU session without a PDU session reestablishment.

The transmission component 904 may transmit, to a target network node based at least in part on supporting the network slice service area, which does not correspond to an existing tracking area, signaling associated with an initiation of a handover, wherein the handover is to the target network node, which is within the network slice service area.

The reception component 902 may receive, from a source network node and based at least in part on supporting the network slice service area, which does not correspond to an existing tracking area, signaling associated with an initiation of a handover, wherein the signaling is not based at least in part on the network slice service area. The communication manager 906 may perform an admission control based at least in part on the network slice service area, wherein the admission control is for a cell that is within the network slice service area.

The reception component 902 may receive, from an AMF and based at least in part on supporting the network slice service area, a location reporting control information that indicates an event type and an area of interest, wherein the event type is associated with a UE presence in the area of interest, and the area of interest is associated with an S-NSSAI, an indication that no user plane resources are configured for the S-NSSAI, and a PDU session identifier that is not associated with user plane resources. The transmission component 904 may transmit, to the AMF and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

The transmission component 904 may transmit, to a UE and based at least in part on supporting the network slice service area, an indication of the network slice service area via dedicated signaling, wherein a network-slice-specific cell reselection is based at least in part on the network slice service area.

The transmission component 904 may transmit, to an AMF and based at least in part on supporting the network slice service area, an indication that a UE has moved to an area that is outside of the network slice service area, wherein the area is associated with no user plane resources, and a PDU session is released based at least in part on the indication, or a user plane connection for the PDU session is deactivated while maintaining the PDU session.

The reception component 902 may receive, from an AMF and based at least in part on supporting the network slice service area, a configuration to deactivate user plane resources of a PDU session of a UE after the UE moves to an area that is outside of the network slice service area and the area is associated with no user plane resources. The communication manager 906 may detect that the UE has moved to the area that is outside of the network slice service area and associated with no user plane resources. The communication manager 906 may initiate a deactivation of the user plane resources. The transmission component 904 may transmit, to the AMF, an indication of the deactivation of the user plane resources. The transmission component 904 may transmit, to the UE and via dedicated signaling, the indication of the deactivation of the user plane resources.

The reception component 902 may receive, from an AMF and based at least in part on supporting the temporary network slice, network slice validity information that indicates time validity information and location restrictions for network slices, wherein the network slice validity information is associated with avoiding triggering an NG interface release due to user inactivity.

The reception component 902 may receive, from an AMF and based at least in part on supporting the partially allowed S-NSSAI, a message that includes an indication of the partially allowed S-NSSAI and an indication of an allowed S-NSSAI. The reception component 902 may receive, from an AMF and based at least in part on supporting the partially rejected S-NSSAI, a message that includes an indication of the partially rejected S-NSSAI and an indication of an allowed S-NSSAI.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by an access and mobility management function (AMF), comprising: communicating signaling associated with supporting one or more of: a network slice service continuity, a network slice service area, a temporary network slice, a partially allowed single-network slice selection assistance information (S-NSSAI), or a partially rejected S-NSSAI; and communicating a response based at least in part on the signaling.
Aspect 2: The method of Aspect 1, wherein communicating the signaling comprises: transmitting, to a network node and based at least in part on supporting the network slice service continuity, an indication of an alternative S-NSSAI during a protocol data unit (PDU) session or modification, wherein the alternative S-NSSAI is associated with an S-NSSAI replacement for an existing PDU session without a PDU session reestablishment.
Aspect 3: The method of any of Aspects 1-2, wherein multiple cells satisfy a conditional handover execution threshold during a conditional handover, and wherein a cell of the multiple cells that is within the network slice service area is prioritized over a cell of the multiple cells that is outside of the network slice service area.
Aspect 4: The method of any of Aspects 1-3, wherein: communicating the signaling comprises transmitting, to a network node and based at least in part on supporting the network slice service area, a location reporting control information that indicates an event type and an area of interest, wherein the event type is associated with a user equipment (UE) presence in the area of interest, and wherein the area of interest is associated with an S-NSSAI, an indication that no user plane resources are configured for the S-NSSAI, and a protocol data unit (PDU) session identifier that is not associated with user plane resources; and communicating the response comprises receiving, from the network node and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.
Aspect 5: The method of any of Aspects 1-4, wherein communicating the signaling comprises: receiving, from a network node and based at least in part on supporting the network slice service area, an indication that a user equipment (UE) has moved to an area that is outside of the network slice service area, wherein the area is associated with no user plane resources, and wherein a protocol data unit (PDU) session is released based at least in part on the indication, or a user plane connection for the PDU session is deactivated while maintaining the PDU session.
Aspect 6: The method of any of Aspects 1-5, wherein communicating the signaling comprises transmitting, to a network node and based at least in part on supporting the network slice service area, a configuration to deactivate user plane resources of a protocol data unit (PDU) session of a user equipment (UE) after the UE moves to an area that is outside of the network slice service area and the area is associated with no user plane resources; and communicating the response comprises receiving, from the network node, an indication of a deactivation of the user plane resources.
Aspect 7: The method of any of Aspects 1-6, wherein communicating the signaling comprises: transmitting, to a network node and based at least in part on supporting the temporary network slice, network slice validity information that indicates time validity information and location restrictions for network slices, wherein the network slice validity information is associated with avoiding triggering a next generation (NG) interface release due to user inactivity.
Aspect 8: The method of any of Aspects 1-7, wherein communicating the signaling comprises: transmitting, to a network node and based at least in part on supporting the partially allowed S-NSSAI, a message that includes an indication of the partially allowed S-NSSAI and an indication of an allowed S-NSSAI.
Aspect 9: The method of any of Aspects 1-8, wherein communicating the signaling comprises: transmitting, to a network node and based at least in part on supporting the partially rejected S-NSSAI, a message that includes an indication of the partially rejected S-NSSAI and an indication of an allowed S-NSSAI.
Aspect 10: A method of wireless communication performed by a network node, comprising: communicating signaling associated with supporting one or more of: a network slice service continuity, a network slice service area, a temporary network slice, a partially allowed single-network slice selection assistance information (S-NSSAI), or a partially rejected S-NSSAI; and communicating a response based at least in part on the signaling.
Aspect 11: The method of Aspect 10, wherein communicating the signaling comprises: receiving, from an access and mobility management function (AMF) and based at least in part on supporting the network slice service continuity, an indication of an alternative S-NSSAI during a protocol data unit (PDU) session or modification, wherein the alternative S-NSSAI is associated with an S-NSSAI replacement for an existing PDU session without a PDU session reestablishment.
Aspect 12: The method of any of Aspects 10-11, wherein the network node is a source network node, and wherein communicating the signaling comprises: transmitting, to a target network node and based at least in part on supporting the network slice service continuity, an indication of an alternative S-NSSAI during a handover or during a retrieval of UE context information, wherein the alternative S-NSSAI is associated with an S-NSSAI replacement for an existing PDU session without a PDU session reestablishment.
Aspect 13: The method of any of Aspects 10-12, wherein the network node is a source network node, and wherein communicating the signaling comprises: transmitting, to a target network node based at least in part on supporting the network slice service area, which does not correspond to an existing tracking area, signaling associated with an initiation of a handover, wherein the handover is to the target network node, which is within the network slice service area.
Aspect 14: The method of any of Aspects 10-13, wherein the network node is a target network node, and wherein communicating the signaling comprises: receiving, from a source network node and based at least in part on supporting the network slice service area, which does not correspond to an existing tracking area, signaling associated with an initiation of a handover, wherein the signaling is not based at least in part on the network slice service area, and further comprising: performing an admission control based at least in part on the network slice service area, wherein the admission control is for a cell that is within the network slice service area.
Aspect 15: The method of any of Aspects 10-14, wherein multiple cells satisfy a conditional handover execution threshold during a conditional handover, and wherein a cell of the multiple cells that is within the network slice service area is prioritized over a cell of the multiple cells that is outside of the network slice service area.
Aspect 16: The method of any of Aspects 10-15, wherein: communicating the signaling comprises receiving, from an access and mobility management function (AMF) and based at least in part on supporting the network slice service area, a location reporting control information that indicates an event type and an area of interest, wherein the event type is associated with a user equipment (UE) presence in the area of interest, and wherein the area of interest is associated with an S-NSSAI, an indication that no user plane resources are configured for the S-NSSAI, and a protocol data unit (PDU) session identifier that is not associated with user plane resources; and communicating the response comprises transmitting, to the AMF and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.
Aspect 17: The method of any of Aspects 10-16, wherein: communicating the signaling comprises transmitting, to a user equipment (UE) and based at least in part on supporting the network slice service area, an indication of the network slice service area via dedicated signaling, wherein a network-slice-specific cell reselection is based at least in part on the network slice service area.
Aspect 18: The method of any of Aspects 10-17, wherein communicating the signaling comprises: transmitting, to an access and mobility management function (AMF) and based at least in part on supporting the network slice service area, an indication that a user equipment (UE) has moved to an area that is outside of the network slice service area, wherein the area is associated with no user plane resources, and wherein a protocol data unit (PDU) session is released based at least in part on the indication, or a user plane connection for the PDU session is deactivated while maintaining the PDU session.
Aspect 19: The method of any of Aspects 10-18, wherein: communicating the signaling comprises receiving, from an access and mobility management function (AMF) and based at least in part on supporting the network slice service area, a configuration to deactivate user plane resources of a protocol data unit (PDU) session of a user equipment (UE) after the UE moves to an area that is outside of the network slice service area and the area is associated with no user plane resources, and further comprising: detecting that the UE has moved to the area that is outside of the network slice service area and associated with no user plane resources; and initiating a deactivation of the user plane resources, and wherein: communicating the response comprises one or more of: transmitting, to the AMF, an indication of the deactivation of the user plane resources; or transmitting, to the UE and via dedicated signaling, the indication of the deactivation of the user plane resources.
Aspect 20: The method of any of Aspects 10-19, wherein communicating the signaling comprises: receiving, from an access and mobility management function (AMF) and based at least in part on supporting the temporary network slice, network slice validity information that indicates time validity information and location restrictions for network slices, wherein the network slice validity information is associated with avoiding triggering a next generation (NG) interface release due to user inactivity.
Aspect 21: The method of any of Aspects 10-20, wherein communicating the signaling comprises: receiving, from an access and mobility management function (AMF) and based at least in part on supporting the partially allowed S-NSSAI, a message that includes an indication of the partially allowed S-NSSAI and an indication of an allowed S-NSSAI.
Aspect 22: The method of any of Aspects 10-21, wherein communicating the signaling comprises: receiving, from an access and mobility management function (AMF) and based at least in part on supporting the partially rejected S-NSSAI, a message that includes an indication of the partially rejected S-NSSAI and an indication of an allowed S-NSSAI.
Aspect 23: An apparatus for wireless communication at a device, comprising a processor; memory coupled with the processor; and instructions stored in the memory and executable by the processor to cause the apparatus to perform the method of one or more of Aspects 1-9.
Aspect 24: A device for wireless communication, comprising a memory and one or more processors coupled to the memory, the one or more processors configured to perform the method of one or more of Aspects 1-9.
Aspect 25: An apparatus for wireless communication, comprising at least one means for performing the method of one or more of Aspects 1-9.
Aspect 26: A non-transitory computer-readable medium storing code for wireless communication, the code comprising instructions executable by a processor to perform the method of one or more of Aspects 1-9.
Aspect 27: A non-transitory computer-readable medium storing a set of instructions for wireless communication, the set of instructions comprising one or more instructions that, when executed by one or more processors of a device, cause the device to perform the method of one or more of Aspects 1-9.
Aspect 28: An apparatus for wireless communication at a device, comprising a processor; memory coupled with the processor; and instructions stored in the memory and executable by the processor to cause the apparatus to perform the method of one or more of Aspects 10-22.
Aspect 29: A device for wireless communication, comprising a memory and one or more processors coupled to the memory, the one or more processors configured to perform the method of one or more of Aspects 10-22.
Aspect 30: An apparatus for wireless communication, comprising at least one means for performing the method of one or more of Aspects 10-22.
Aspect 31: A non-transitory computer-readable medium storing code for wireless communication, the code comprising instructions executable by a processor to perform the method of one or more of Aspects 10-22.
Aspect 32: A non-transitory computer-readable medium storing a set of instructions for wireless communication, the set of instructions comprising one or more instructions that, when executed by one or more processors of a device, cause the device to perform the method of one or more of Aspects 10-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at an access and mobility management function (AMF), comprising:
a memory; and
one or more processors, coupled to the memory, configured to:
communicate signaling associated with supporting one or more of:
a network slice service continuity, a network slice service area,
a temporary network slice, a partially allowed single-network slice selection assistance information (S-NSSAI), or a partially rejected S-NSSAI; and
communicate a response based at least in part on the signaling.

2. The apparatus of claim 1, wherein the one or more processors, to communicate the signaling, are configured to:
transmit, to a network node and based at least in part on supporting the network slice service continuity, an indication of an alternative S-NSSAI during a protocol data unit (PDU) session or modification, wherein the alternative S-NSSAI is associated with an S-NSSAI replacement for an existing PDU session without a PDU session reestablishment.

3. (canceled)

4. The apparatus of claim 1, wherein:
the one or more processors, to communicate the signaling, are configured to transmit, to a network node and based at least in part on supporting the network slice service area, a location reporting control information that indicates an event type and an area of interest, wherein the event type is associated with a user equipment (UE) presence in the area of interest, and wherein the area of interest is associated with an S-NSSAI, an indication that no user plane resources are configured for the S-NSSAI, and a protocol data unit (PDU) session identifier that is not associated with user plane resources; and
the one or more processors, to communicate the response, are configured to receive, from the network node and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

5. The apparatus of claim 1, wherein the one or more processors, to communicate the signaling, are configured to:
receive, from a network node and based at least in part on supporting the network slice service area, an indication that a user equipment (UE) has moved to an area that is outside of the network slice service area, wherein the area is associated with no user plane resources, and wherein a protocol data unit (PDU) session is released based at least in part on the indication, or a user plane connection for the PDU session is deactivated while maintaining the PDU session.

6. The apparatus of claim 1, wherein
the one or more processors, to communicate the signaling, are configured to transmit, to a network node and based at least in part on supporting the network slice service area, a configuration to deactivate user plane resources of a protocol data unit (PDU) session of a user equipment (UE) after the UE moves to an area that is outside of the network slice service area and the area is associated with no user plane resources; and
the one or more processors, to communicate the response, are configured to receive, from the network node, an indication of a deactivation of the user plane resources.

7. The apparatus of claim 1, wherein the one or more processors, to communicate the signaling, are configured to:
transmit, to a network node and based at least in part on supporting the temporary network slice, network slice validity information that indicates time validity information and location restrictions for network slices, wherein the network slice validity information is associated with avoiding triggering a next generation (NG) interface release due to user inactivity.

8. The apparatus of claim 1, wherein the one or more processors, to communicate the signaling, are configured to:
transmit, to a network node and based at least in part on supporting the partially allowed S-NSSAI, a message that includes an indication of the partially allowed S-NSSAI and an indication of an allowed S-NSSAI.

9. The apparatus of claim 1, wherein the one or more processors, to communicate the signaling, are configured to:
transmit, to a network node and based at least in part on supporting the partially rejected S-NSSAI, a message that includes an indication of the partially rejected S-NSSAI and an indication of an allowed S-NSSAI.

10. An apparatus for wireless communication at a network node, comprising:
a memory; and
one or more processors, coupled to the memory, configured to:
communicate signaling associated with supporting one or more of: a network slice service continuity,
a network slice service area,
a temporary network slice,
a partially allowed single-network slice selection assistance information (S-NSSAI), or a partially rejected S-NSSAI; and
communicate a response based at least in part on the signaling.

11. The apparatus of claim 10, wherein the one or more processors, to communicate the signaling, are configured to:
receive, from an access and mobility management function (AMF) and based at least in part on supporting the network slice service continuity, an indication of an alternative S-NSSAI during a protocol data unit (PDU) session or modification, wherein the alternative S-NSSAI is associated with an S-NSSAI replacement for an existing PDU session without a PDU session reestablishment.

12. The apparatus of claim 10, wherein the network node is a source network node, and wherein the one or more processors, to communicate the signaling, are configured to:
transmit, to a target network node and based at least in part on supporting the network slice service continuity, an indication of an alternative S-NSSAI during a handover or during a retrieval of UE context information, wherein the alternative S-NSSAI is associated with an S-NSSAI replacement for an existing PDU session without a PDU session reestablishment.

13. The apparatus of claim 10, wherein the network node is a source network node, and wherein the one or more processors, to communicate the signaling, are configured to:
transmit, to a target network node based at least in part on supporting the network slice service area, which does not correspond to an existing tracking area, signaling associated with an initiation of a handover, wherein the handover is to the target network node, which is within the network slice service area.

14. The apparatus of claim 10, wherein the network node is a target network node, and wherein the one or more processors, to communicate the signaling, are configured to:
receive, from a source network node and based at least in part on supporting the network slice service area, which does not correspond to an existing tracking area, signaling associated with an initiation of a handover, wherein the signaling is not based at least in part on the network slice service area; and
wherein the one or more processors are configured to perform an admission control based at least in part on the network slice service area, wherein the admission control is for a cell that is within the network slice service area.

15. (canceled)

16. The apparatus of claim 10, wherein:
the one or more processors, to communicate the signaling, are configured to receive, from an access and mobility management function (AMF) and based at least in part on supporting the network slice service area, a location reporting control information that indicates an event type and an area of interest, wherein the event type is associated with a user equipment (UE) presence in the area of interest, and wherein the area of interest is associated with an S-NSSAI, an indication that no user plane resources are configured for the S-NSSAI, and a protocol data unit (PDU) session identifier that is not associated with user plane resources; and
the one or more processors, to communicate the response, are configured to transmit, to the AMF and based at least in part on supporting the network slice service area, a location report that indicates the UE presence in the area of interest, the location report being based at least in part on a UE moving outside of the network slice service area, which is associated with the S-NSSAI, or based at least in part on the UE moving to a cell in which no user plane resources are allocated for the S-NSSAI.

17. The apparatus of claim 10, wherein:
the one or more processors, to communicate the signaling, are configured to transmit, to a user equipment (UE) and based at least in part on supporting the network slice service area, an indication of the network slice service area via dedicated signaling, wherein a network-slice-specific cell reselection is based at least in part on the network slice service area.

18. The apparatus of claim 10, wherein the one or more processors, to communicate the signaling, are configured to:
transmit, to an access and mobility management function (AMF) and based at least in part on supporting the network slice service area, an indication that a user equipment (UE) has moved to an area that is outside of the network slice service area, wherein the area is associated with no user plane resources, and wherein a protocol data unit (PDU) session is released based at least in part on the indication, or a user plane connection for the PDU session is deactivated while maintaining the PDU session.

19. The apparatus of claim 10, wherein:
the one or more processors, to communicate the signaling, are configured to receive, from an access and mobility management function (AMF) and based at least in part on supporting the network slice service area, a configuration to deactivate user plane resources of a protocol data unit (PDU) session of a user equipment (UE) after the UE moves to an area that is outside of the network slice service area and the area is associated with no user plane resources;
the one or more processors are further configured to:
detect that the UE has moved to the area that is outside of the network slice service area and associated with no user plane resources; and
initiate a deactivation of the user plane resources; and
the one or more processors, to communicate the response, are configured to: transmit, to the AMF, an indication of the deactivation of the user plane resources; or
transmit, to the UE and via dedicated signaling, the indication of the deactivation of the user plane resources.

20. The apparatus of claim 10, wherein the one or more processors, to communicate the signaling, are configured to:
receive, from an access and mobility management function (AMF) and based at least in part on supporting the temporary network slice, network slice validity information that indicates time validity information and location restrictions for network slices, wherein the network slice validity information is associated with avoiding triggering a next generation (NG) interface release due to user inactivity.

21. The apparatus of claim 10, wherein the one or more processors, to communicate the signaling, are configured to:
receive, from an access and mobility management function (AMF) and based at least in part on supporting the partially allowed S-NSSAI, a message that includes an indication of the partially allowed S-NSSAI and an indication of an allowed S-NSSAI; or
receive, from the AMF and based at least in part on supporting the partially rejected S-NSSAI, a message that includes an indication of the partially rejected S-NSSAI and the indication of the allowed S-NSSAI.

22. A method of wireless communication performed by an access and mobility management function (AMF), comprising:
communicating signaling associated with supporting one or more of:
a network slice service continuity,
a network slice service area,
a temporary network slice,
a partially allowed single-network slice selection assistance information (S-NSSAI), or a partially rejected S-NSSAI; and
communicating a response based at least in part on the signaling.

23-30. (canceled)
